(19) United States
(12) Patent Application Publication
(10) Pub. No.: US 2017/0156989 A1
(43) Pub. Date: Jun. 8, 2017

(54) INFANT CLOTHING INCORPORATING A TEETHING SURFACE

(71) Applicant: RPF Developments Ltd., Essex (GB)

(72) Inventor: Kylie Hunter, Essex (GB)

(21) Appl. No.: 14/957,690

(22) Filed: Dec. 3, 2015

(51) Int. Cl. A61J 17/02

(52) U.S. Cl. CPC A61J 17/02

(57) ABSTRACT

To ensure a teething object is always available to an infant the invention describes an article of infants clothing incorporating a teething surface 50 provided on the surface of one end of an arm 10 of the clothing, the end of the arm of the clothing being configured such that in a first position the teething surface is outermost and accessible by the infant, and in a second position the teething surface is at least partially hidden from view and inaccessible by the infant.

### FIELD OF THE INVENTION

The present invention relates generally to an article of infant clothing incorporating a teething surface, and finds particular, although not exclusive, utility in providing an alternative to teething rings.

### BACKGROUND

Teething rings and other shaped products (known generically as “teethers”) for teething have long been known. One of the problems with them is that often get dropped, thus potentially becoming dirty, and/or get lost. Although it is possible to attach teethers to other items such as push chairs, and cots, these are often not near located in the place where the infant is at the time of need.

It would therefore be advantageous to have a teether which was available to an infant more readily.

### BRIEF DESCRIPTION

In one aspect, the invention provides an article of infants clothing incorporating a teething surface provided on the surface of one end of an arm of the clothing, the end of the arm of the clothing being configured such that in a first position the teething surface is outermost and accessible by the infant, and in a second position the teething surface is at least partially hidden from view and inaccessible by the infant.

The teething surface may be completely hidden from view when the end of the arm is in the second position.

The arm may be configured such that the second position is obtainable by folding at least a portion of the end of the arm over at least another immediately adjacent portion. In one embodiment, the article of clothing may include at least one arm which has a length longer than necessary when unfolded. The distal end may be folded over the immediately proximal portion, in the manner of a double cuff. The teething surface may be located within the double cuff such that it is completely, or at least partially, hidden from view on the inside of the folded cuff.

When in the first position the distal end of the end of the arm may be configured to extend over the infant's hand such that it is readily available to the infant to place in its mouth for the purpose of teething.

In this way, an adult may fold-out the end of the arm when the infant is teething. When the adult wants the infant to stop teething on the teething surface, for instance at meal times, the teething surface can be wiped clean with a sterilising material and then the end of the arm can be folded back over the teething surface to hide it from view. The teething surface is then ready for the next use.

The article may be considered to be a teething mitten.

The teething surface may be a sheet of material. In this regard the sheet may be laminar. It may be homogenous. It may be solid. It may be unbroken. It may be continuous with no holes. It may be non-woven. It may include at least one hole. It may be uniform.

The teething surface may be elastomeric. It may be at least partially elastomeric.

The teething surface may comprise any one or more of natural rubber, synthetic rubber, silicone, silicone rubber, and plastics.

The item of clothing may be a onesie. In this regard a onesie may be defined as an article of clothing which includes continuous connected portions which extend around the wearer's torso, arms and legs.

The item of clothing may be a shirt. It may be a “T” shirt. It may be a long or short sleeved “T” shirt. It may be an article of clothing which includes long sleeves.

The item of clothing may be an infant bodysuit. The item of clothing may be an infant sweatshirt. The item of clothing may be an infant jacket.

The item of teething surface may have a thickness in the range 1 to 5 mm. However, other ranges of thickness are contemplated such as 1 to 8 mm.

The teething surface may not be uniform in thickness having relatively thin and thick portions.

### BRIEF DESCRIPTION OF THE DRAWINGS

The above and other characteristics, features and advantages of the present invention will become apparent from the following detailed description, taken in conjunction with the accompanying drawings, which illustrate, by way of example, the principles of the invention.

This description is given for the sake of example only, without limiting the scope of the invention. The reference figures quoted below refer to the attached drawings.

FIG. 1 is a view of a portion of an article of clothing with the end of the arm folded over; and

FIG. 2 is a view of the portion of clothing of FIG. 1 with the end of the arm folded-out such that the teething surface is visible and accessible.

### DETAILED DESCRIPTION

The present invention will be described with respect to certain drawings but the invention is not limited thereto but only by the claims. The drawings described are only schematic and are non-limiting. Each drawing may not include all of the features of the invention and therefore should not necessarily be considered to be an embodiment of the invention. In the drawings, the size of some of the elements may be exaggerated and not drawn to scale for illustrative purposes. The dimensions and the relative dimensions do not correspond to actual reductions to practice of the invention.

Furthermore, the terms first, second, third and the like in the description and in the claims, are used for distinguishing between similar elements and not necessarily for describing a sequence, either temporally, spatially, in ranking or in any other manner. It is to be understood that the terms so used are interchangeable under appropriate circumstances and that operation is capable in other sequences than described or illustrated herein.

Moreover, the terms top, bottom, over, under and the like in the description and the claims are used for descriptive purposes and not necessarily for describing relative positions. It is to be understood that the terms so used are interchangeable under appropriate circumstances and that operation is capable in other orientations than described or illustrated herein.

It is to be noticed that the term “comprising”, used in the claims, should not be interpreted as being restricted to the means listed thereafter; it does not exclude other elements or steps. It is thus to be interpreted as specifying the presence of the stated features, integers, steps or components as referred to, but does not preclude the presence or addition of one or more other features, integers, steps or components, or groups thereof. Thus, the scope of the expression “a device comprising means A and B” should not be limited to devices consisting only of components A and B. It means that with respect to the present invention, the only relevant components of the device are A and B.

Reference throughout this specification to “an embodiment” or “an aspect” means that a particular feature, structure or characteristic described in connection with the embodiment or aspect is included in at least one embodiment or aspect of the present invention. Thus, appearances of the phrases “in one embodiment”, “in an embodiment”, or “in an aspect” in various places throughout this specification are not necessarily all referring to the same embodiment or aspect, but may refer to different embodiments or aspects. Furthermore, the particular features, structures or characteristics of any embodiment or aspect of the invention may be combined in any suitable manner, as would be apparent to one of ordinary skill in the art from this disclosure, in one or more embodiments or aspects.

Similarly, it should be appreciated that in the description various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Moreover, the description of any individual drawing or aspect should not necessarily be considered to be an embodiment of the invention. Rather, as the following claims reflect, inventive aspects lie in fewer than all features of a single foregoing disclosed embodiment. Thus, the claims following the detailed description are hereby expressly incorporated into this detailed description, with each claim standing on its own as a separate embodiment of this invention.

Furthermore, while some embodiments described herein include some features included in other embodiments, combinations of features of different embodiments are meant to be within the scope of the invention, and form yet further embodiments, as will be understood by those skilled in the art. For example, in the following claims, any of the claimed embodiments can be used in any combination.

In the description provided herein, numerous specific details are set forth. However, it is understood that embodiments of the invention may be practised without these specific details. In other instances, well-known methods, structures and techniques have not been shown in detail in order not to obscure an understanding of this description.

In the discussion of the invention, unless stated to the contrary, the disclosure of alternative values for the upper or lower limit of the permitted range of a parameter, coupled with an indication that one of said values is more highly preferred than the other, is to be construed as an implied statement that each intermediate value of said parameter, lying between the more preferred and the less preferred of said alternatives, is itself preferred to said less preferred value and also to each value lying between said less preferred value and said intermediate value.

The use of the term “at least one” may mean only one in certain circumstances.

The principles of the invention will now be described by a detailed description of at least one drawing relating to exemplary features of the invention. It is clear that other arrangements can be configured according to the knowledge of persons skilled in the art without departing from the underlying concept or technical teaching of the invention, the invention being limited only by the terms of the appended claims.

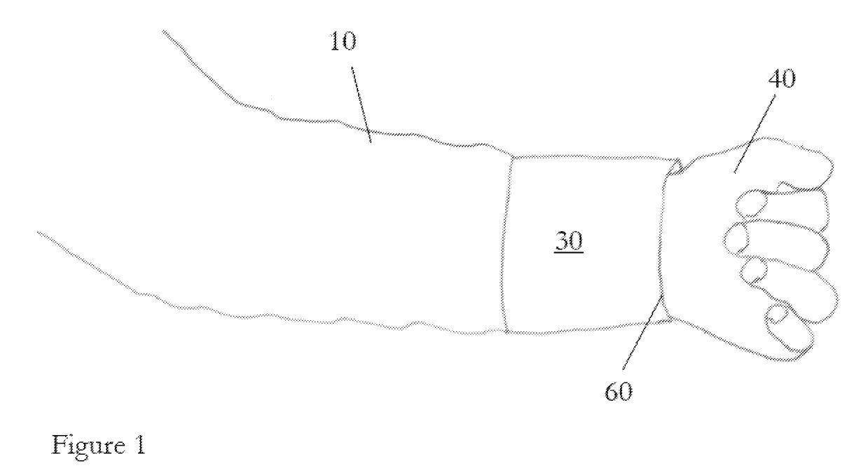

In FIG. 1, a sleeve 10 of an item of clothing is shown. At one end a cuff 30 is shown folded-over such that the wearer's hand 40 is visible poking out of the end of the sleeve 10. The extreme distal end of the cuff 30 is referenced “60”.

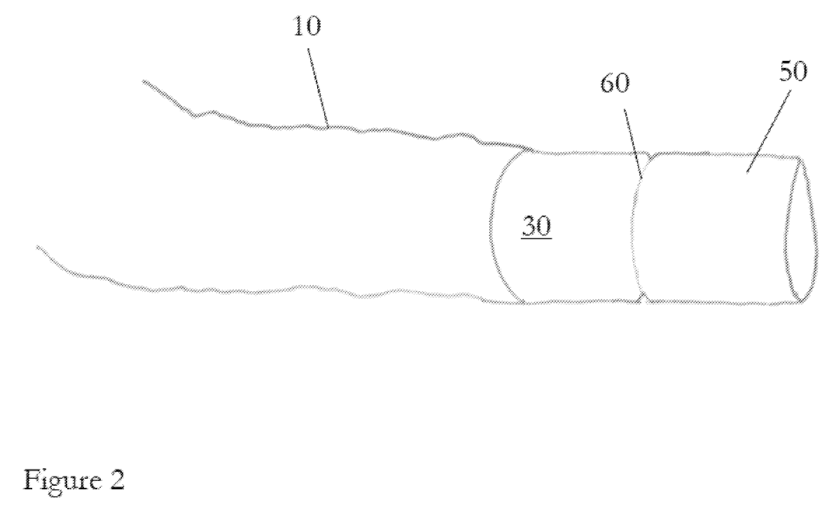

In FIG. 2, the cuff 30 has been unfolded such that the inside of the cuff 30 is visible and accessible. The inside of the cuff 30 in this instance entirely comprises a sheet of teething material 50. However, the teething material 50 may be smaller than the whole of the area of the inside of the cuff and may only occupy a portion of the inside of the cuff 30.

The fold 60 is visible on the teething surface 50 which indicates the portion of the cuff which was the extreme distal end, when folded-out, as shown in FIG. 1.

The teething material 50 may be attached to the material of the sleeve 10 such that the material of the sleeve is a backing layer. Alternatively the teething material may comprise an entire portion of the sleeve without a backing layer. A combination of the two may also be possible.

With the sleeve unfolded as shown in FIG. 2 the wearer's hand 40 is not visible. However, in one embodiment, the cuff, when unfolded, may not cover all of the hand of the wearer such that at least a portion of the hand is visible and not covered by the cuff 30.

The article of clothing may include attachment means for securing the cuff in the folded state such that the teething material is inaccessible. For instance, any of poppers, hook and loop material, and buttons may be used.

In one embodiment, the teething portion may be retro-fittable to an existing item of clothing. In this case the teething portion may include attachment means for attaching it to the sleeve of an existing item of clothing. The attachment means may be any of a strap, zip, poppers, hook and loop material, buttons, etc.

1. An article of infant clothing incorporating a teething surface provided on the surface of one end of an arm of the clothing, the end of the arm of the clothing being configured such that in a first position the teething surface is outermost and accessible by the infant, and in a second position the teething surface is at least partially hidden from view and inaccessible by the infant.

2. The article of clothing according to claim 1, wherein the arm is configured such that the second position is obtainable by folding at least a portion of the end of the arm over at least another immediately adjacent portion.

3. The article of clothing according to either one of claims 1 and 2, wherein the teething surface is a sheet of material.

4. The article of clothing according to claim 1, wherein the teething surface is elastomeric.

5. The article of clothing according to claim 1, wherein the teething surface comprises any one or more of natural rubber, synthetic rubber, silicone, silicone rubber, and plastics.

6. The article of clothing according to claim 1, wherein the item of clothing is a onesie.

7. The article of clothing according to claim 1, wherein the item of clothing is a shirt.

8. The article of clothing according to claim 1, wherein the item of clothing is an infant bodysuit.

9. The article of clothing according to claim 1, wherein the item of clothing is an infant sweatshirt.

10. The article of clothing according to claim 1, wherein the item of clothing is an infant jacket.

11. The article of clothing according to claim 1, wherein the item of teething surface has a thickness in the range 1 to 5 mm.
